(19) United States
(12) Patent Application Publication
(10) Pub. No.: US 2025/0163589 A1
(43) Pub. Date: May 22, 2025

(54) METHOD FOR THE ELECTROCHEMICAL SYNTHESIS OF AMMONIA AND INSTALLATION FOR CARRYING OUT THE METHOD

(71) Applicant: GENCELL LTD., Petah Tikva (IL)

(72) Inventors: Gennadi Finkelshtain, Modiin (IL); NIno Borchtchoukova, Modiin (IL); Joseph Alexander Englander, Petah-Tikva (IL); Yanir Kadosh, Pardesiya (IL); Ron Yosef Loew, Raanana (IL); Kachal Hirshberg, Tel Aviv Yafo (IL); Michael Liskovich, Petah Tikva (IL)

(21) Appl. No.: 18/514,260

(22) Filed: Nov. 20, 2023

(51) Int. Cl. C25B 1/27; C25B 1/50; C25B 11/061; C25B 11/081

(52) U.S. Cl. CPC C25B 1/27; C25B 1/50; C25B 11/061; C25B 11/081

(57) ABSTRACT

A method for the electrochemical synthesis of ammonia comprises:
(a) forming from a gas mixture comprising nitrogen and oxygen an atmospheric pressure nonthermal plasma (APNTP) in a plasma device,
(b) introducing the APNTP into an aqueous electrolyte solution to form a solution of one or more species of formula NOₓ⁻,
(c) contacting the solution of (b) with the cathode of an electrochemical cell which comprises a catalyst which is capable of catalyzing the electrochemical reduction of the one or more species of formula NOₓ⁻ to NH₃, and
(d) applying a potential or current over the electrochemical cell to effect the electrochemical synthesis of ammonia.

### BACKGROUND OF THE INVENTION

### 1. Field of the Invention

The present invention relates to a method for the synthesis of ammonia by electrochemically reducing reactive nitrogen-oxygen species formed from air and an installation (system) and catalyst for use in the method.

### 2. Discussion of Background Information

Ammonia (NH₃) is a widely crucial chemical, which is currently commonly produced in large-scale by the one-step Haber-Bosch (H-B) process. Ammonia production by this process is energetically demanding and is also associated with low efficiencies. The century-old Haber-Bosch process for ammonia synthesis requires harsh operating conditions including high temperatures (400-500° C.) and high pressures (150-300 atm) using pure N₂ and H₂ gases together with heterogeneous iron-based catalysts. Thus, the Haber-Bosch process is costly and requires significant plant infrastructure. Ammonia (NH₃) had a worldwide production of 235 million tons in 2019, which accounts for 1-2% of the world's energy supply and causes ca. 1% of total global energy-related CO₂ emissions. An emerging alternative to the Haber-Bosch process is the electrochemical synthesis of ammonia through the nitrogen reduction reaction (eNRR). The electrocatalytic reduction process is considered as an environmentally friendly approach for NH₃ production; in fact, it can be performed under mild conditions, such as room temperature and atmospheric pressure, and it can also be powered by renewable energy. Furthermore, the NRR performed in an aqueous environment eliminates the demand for a pure H₂ source as a reactant in the reduction reaction. However, the direct electrochemical conversion of N₂ to ammonia suffers from disadvantages such as an extremely low NH₃ yield and a low Faradaic efficiency. These disadvantages arise due to the highly unreactive nature of N₂ and its low solubility and diffusion ability in the electrolyte. Moreover, the electrochemical NRR is hampered by a competition with the hydrogen evolution reaction (HER), as the hydrogen generation usually occurs at a lower overpotential than the eNRR.

It has now been found that the disadvantages relating to the eNRR can be overcome by the activation of N₂ into a more reactive intermediate form. Attractive intermediate species are charged nitrogen oxides (NOₓ⁻) as starting materials for the electrochemical ammonia synthesis, due to their relatively low N—O bond dissociation energy and superior solubility in water. Inspired by the natural lightning fixation of nitrogen, and the rapid development of the atmospheric pressure nonthermal plasma (APNTP) technology, the activation of N₂, in the presence of O₂, into reactive nitrogen oxide species of formula NOₓ has been found to be achievable by energetic electrons of a plasma. An additional advantage of APNTP is that air may be used directly as a gas source and starting material for converting N₂ into nitrogen oxide species that can then be absorbed by the electrolyte to form reactive negatively charged species of formula NOₓ⁻ (mainly nitrite and to a lesser extent nitrate), which in turn can be directly reduced to ammonia at the cathode of an electrochemical cell.

The reduction reactions of NOₓ⁻ that occur in the electrochemical cell are:

NO₃⁻+9 H⁺+8e⁻→NH₃+3H₂O E°=0.88 V vs. RHE

NO₂⁻+7H⁺+6e⁻NH₃+2H₂O E°=0.86V vs.RHE

The key to achieving a selective electrocatalytic NOₓ⁻-to-NH₃ conversion at relatively low potentials is a rational design and electrocatalysts with the ability to favorably catalyze the reduction of NOₓ⁻ while concurrently supplying sufficient H* and e⁻ that can participate in an intermediate hydrogenation in the alkaline electrolyte rather than undergoing dimerization to form H₂. The additional tuning of components in, e.g., the electrochemical nitrate reduction reaction (NitRR) system, such as electrolyte, electrodes, and applied potentials can also contribute to a high ammonia yield and Faradaic efficiency.

### SUMMARY OF THE INVENTION

The present invention provides a method for the electrochemical synthesis of ammonia.

### The Method Comprises:

(a) forming from a gas mixture which comprises nitrogen and oxygen as starting material an atmospheric pressure nonthermal plasma (APNTP) in a plasma device,
(b) introducing the formed APNTP in the plasma device into an aqueous electrolyte solution, alkaline or neutral, to form a solution of one or more species of formula NOₓ in which x is 1, 2 or 3,
(c) contacting the solution of (b) with a cathode of an electrochemical cell which comprises the cathode, an anode and an aqueous electrolyte, the cathode comprising a catalyst A which is capable of catalyzing the electrochemical reduction of the one or more species of formula NOₓ⁻ to NH₃ at the cathode, and the anode comprising a catalyst which is capable of catalyzing the electrochemical oxidation of water into oxygen (O₂), and
(d) applying a potential or current over the electrochemical cell to effect the electrochemical synthesis of ammonia.

In one embodiment of the method, in step (a) the APNTP is formed by direct application of an electric field across electrodes and/or a compressed gas mixture which comprises nitrogen and oxygen (e.g., air or oxygen-enriched air) is employed for forming the plasma. For example, the compressed gas mixture may be at a pressure of from 2 bar to 10 bar and/or the flow rate of the gas mixture in the plasma device may be from 0.1 L/min to 1 L/min and/or the voltage of the plasma device may be from 10 kV to 20 kV. For example, the compressed gas mixture may comprise oxygen and nitrogen at a molar ratio of from 95:5 to 5:95.

In one embodiment, the aqueous electrolyte solution employed in step (b) of the method of the invention comprises an alkali and/or alkaline earth metal hydroxide. For example, the alkali and/or alkaline earth metal hydroxide may consist of or comprise KOH. The concentration of the alkali and/or alkaline earth metal hydroxide in the solution may, for example, be from 0.1M to 3M.

In one embodiment, the electrochemical cell further comprises a separator, for example a separator which comprises an anion exchange membrane.

In one embodiment, the aqueous electrolyte in the electrochemical cell is an aqueous solution of an alkali and/or alkaline earth metal hydroxide. For example, the alkali or alkaline earth metal hydroxide may consist of or comprise KOH and/or the concentration of the alkali and/or alkaline earth metal hydroxide in the alkaline aqueous electrolyte may be from 0.1M to 6.6M such as, e.g., from 1M to 3M. The aqueous electrolyte in the electrochemical cell may be the same or substantially the same as the alkaline aqueous solution employed in step (b) of the method of the invention. However, the aqueous electrolyte may also be substantially neutral and may, for example comprise Na₂SO₄ or any other water-soluble sulfate. For example, the electrolyte may be an aqueous salt solution with a pH of from 6.5 to 7.5, using 0.1M to 3M Na₂SO₄.

In one embodiment of the method, the one or more species of formula NOₓ⁻ comprise at least nitrite (NO₂⁻) species.

In one embodiment, the concentration of the one or more species of formula NOₓ⁻ in the solution employed in step (b) is from 0.1 mM to 50 mM, e.g., from 1 mM to 30 mM.

In one embodiment of the method of the invention, the catalyst A which is capable of catalyzing the electrochemical reduction of the one or more species of formula NOₓ⁻ to NH₃ at the cathode of the electrochemical cell comprises one or more of Ni, Co, Ru, Pt, Cu, Fe, La, Y, Ce, Ti, Pd, B. Sr, Ba, W, Rh, Au, Cr, Re, Os, In, Pb, Sb. For example, catalyst A may comprise at least Ru and Cu, e.g., in an atomic ratio Ru:Cu of from 90:10 to 10:90. Further, catalyst A may be present on a mesh such as, e.g., a Ni mesh. Catalyst A may also be present in and/or on a carbon-based or metallic foam, felt, cloth, sponge, mesh. Catalyst A may further be present in the form of particles, for example particles having a size in the range of from 1 nm to 100 μm. Additionally, catalyst A may be present in the form of dispersed single atoms of clusters of atoms.

The present invention further provides an installation (also referred to herein as “system”) for carrying out the method of the instant invention as set forth above (including the various embodiments thereof). The installation comprises at least (i) a plasma device which capable of forming from a gas mixture comprising nitrogen and oxygen an APNTP and (ii) an electrochemical cell which comprises a cathode, an anode and an aqueous electrolyte, the cathode comprising a catalyst A which is capable of catalyzing the electrochemical reduction of one or more species of formula NOₓ⁻ to NH₃ at the cathode of the electrochemical cell.

In one embodiment of the installation, the plasma device is configured to form the APNTP by direct application of an electric field across electrodes. For example, the voltage of the plasma device may be from 10 kV to 20 kV.

In one embodiment, the aqueous electrolyte comprises an alkali and/or alkaline earth metal hydroxide. For example, the alkali and/or alkaline earth metal hydroxide may consist of or comprise KOH and/or the concentration of the alkali and/or alkaline earth metal hydroxide in the electrolyte may be from 0.1M to 6.6M. However, the aqueous electrolyte may also be substantially neutral and may, for example, comprise Na₂SO₄ or any other water-soluble sulfate. For example, the electrolyte may be an aqueous salt solution with a pH of from 6.5 to 7.5, using 0.1M to 3M Na₂SO₄.

In one embodiment, the electrochemical cell further comprises a separator, for example a separator which comprises an anion exchange membrane.

In one embodiment of the installation, the catalyst A which is capable of catalyzing the electrochemical reduction of the one or more species of formula NOₓ⁻ to NH₃ at the cathode of the electrochemical cell comprises one or more of Ni, Co, Ru, Pt, Cu, Fe, La, Y, Ce, Ti, Pd, B. Sr, Ba, W, Rh, Au, Cr, Re, Os, In, Pb, Sb. For example, catalyst A may comprise at least Ru and Cu, e.g., in an atomic ratio Ru:Cu of from 90:10 to 10:90. Further, catalyst A may be present on a mesh such as, e.g., a Ni mesh.

In one embodiment of the installation, the installation further comprises a receptacle/reservoir which contains an aqueous electrolyte solution for receiving the APNTP in the plasma device. For example, the aqueous electrolyte solution may comprise an alkali and/or alkaline earth metal hydroxide. The alkali and/or alkaline earth metal hydroxide may consist of or comprise KOH and/or the concentration of the alkali and/or alkaline earth metal hydroxide in the aqueous solution may be from 0.1M to 6.6M. However, the aqueous electrolyte solution may also be substantially neutral and may, for example, comprise Na₂SO₄ or any other water-soluble sulfate salt. For example, the solution may be an aqueous salt solution with a pH of from 6.5 to 7.5, using 0.1M to 3M Na₂SO₄.

In one embodiment, the installation further comprises a potentiostat and/or a galvanostat.

The present invention further provides a method of converting a gas mixture which comprises nitrogen and oxygen into one or more species of formula NOₓ⁻ in which x is 1, 2 or 3.

The method comprises forming from the gas mixture as starting material an APNTP and introducing the formed APNTP into an alkaline aqueous solution to form a solution of the one or more species of formula NOₓ⁻ in the alkaline aqueous solution.

In one embodiment, the one or more species of formula NOₓ⁻ comprise at least nitrite (NO₂).

In one embodiment of the method, the APNTP is formed by direct application of an electric field across electrodes and/or a compressed gas mixture which comprises nitrogen and oxygen (e.g., air or air enriched with oxygen) is employed. For example, the pressure of the gas mixture may be from 2 bar to 10 bar and/or the flow rate of air in the plasma device may be from 0.1 L/min to 1 L/min and/or the voltage of the plasma device may be from 10 kV to 20 kV.

In one embodiment of the method, the alkaline aqueous solution comprises an alkali and/or alkaline earth metal hydroxide. For example, the alkali and/or alkaline earth metal hydroxide may consist of or comprise KOH and/or the concentration of the alkali and/or alkaline earth metal hydroxide in the solution may be from 0.1M to 3M.

The present invention also provides a catalyst for catalyzing the electrochemical synthesis of ammonia. The catalyst is capable of catalyzing the reduction of species of formula NOₓ⁻ in which x is 1, 2 or 3 to ammonia at the cathode of an electrochemical cell. The catalyst comprises at least Cu and Ru, for example in an atomic ratio of from 90:10 to 10:90.

In one embodiment, the catalyst is present on a Ni mesh, e.g., in the form of a nano sponge (coral-like).

In one embodiment, the catalyst is obtainable by reducing an aqueous solution of a Cu salt and a Ru salt. The reducing agent may, for example, be or comprise NaBH₄. However, other reducing agents such as ethylene glycol, hydrogen, hydrazine, Na₄O₆P₂ and C₂H₆O may be suitable as well.

### BRIEF DESCRIPTION OF THE DRAWINGS

The present invention is further described in the detailed description which follows, in reference to the accompanying drawings by way of non-limiting examples of exemplary embodiments of the present invention. In the drawings:

FIG. 1 schematically shows the design of a plasma assisted device prototype for the electrochemical synthesis that was used in the experiments described below;

FIG. 2 graphically represents the results of linear sweep voltammetry obtained with differently treated nickel mesh samples with and without the presence of nitrate ions in the electrolyte in the experiments described below;

FIG. 3 graphically represents the results of linear sweep voltammetry obtained with an acid etched Ni mesh at different concentrations of nitrate ions in the electrolyte in the experiments described below;

FIG. 4 graphically represents the ammonia production rate and the Faradaic efficiency obtained with an acid-etched Ni mesh as a function of the applied potential in the experiments described below; and

FIG. 5 graphically represents the ammonia production rate and the Faradaic efficiency obtained with an acid-etched Ni mesh as a function of the applied potential under conditions different from those employed with respect to FIG. 4 in the experiments described below.

### DETAILED DESCRIPTION OF EMBODIMENTS OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

As used herein, the singular forms “a,” “an,” and “the” include the plural reference unless the context clearly dictates otherwise. For example, reference to “a catalyst” would also mean that mixtures of two or more catalysts can be present unless specifically excluded.

Except where otherwise indicated, all numbers expressing quantities of ingredients, reaction conditions, etc. used in the instant specification and appended claims are to be understood as being modified in all instances by the term “about.” Accordingly, unless indicated to the contrary, the numerical parameters set forth in the present specification and the appended claims are approximations that may vary depending upon the desired properties sought to be obtained by the present invention. At the very least, each numerical parameter should be construed in light of the number of significant digits and ordinary rounding conventions.

Additionally, the disclosure of numerical ranges within this specification is considered to be a disclosure of all numerical values and ranges within that range. For example, if a range is from 0.1 to 50, it is deemed to include, for example, 0.3, 1, 7, 34, 46.1, 23.7, or any other value or range within the range.

As stated above, the method of the invention for the electrochemical synthesis of ammonia comprises:
(a) forming from a gas mixture comprising nitrogen and oxygen as starting material an atmospheric pressure nonthermal plasma (APNTP) in a plasma device,
(b) introducing the formed APNTP in the plasma device into an aqueous electrolyte solution, alkaline or neutral, to form a solution of one or more species of formula NOₓ in which x is 1, 2 or 3,
(c) contacting the solution of step (b) with a cathode of an electrochemical cell which comprises the cathode, an anode (and preferably a separator) and an aqueous electrolyte, the cathode comprising a catalyst A which is capable of catalyzing the electrochemical reduction of the one or more species of formula NOₓ⁻ to NH₃ at the cathode, and
(d) applying a potential or current over the electrochemical cell to effect the electrochemical synthesis of ammonia.

If air is to be used as a component of the gas mixture, it may be admixed with oxygen to increase the amount of active N—O species and to favor the formation of nitrite over the formation of nitrate upon introduction of the plasma into the alkaline aqueous solution. The molar ratio of nitrogen (N₂) to oxygen (O₂) in the gas mixture is not particularly limited but will usually be from 95:5 to 5:95, e.g., from 90:10 to 10:90, from 85:15 to 15:85, from 80:20 to 20:80, from 75:25 to 25:75, from 70:30 to 30:70, or from 60:40 to 40:60. The ratio of nitrogen to oxygen in air alone is about 81:19.

In step (a) the APNTP may be formed by direct application of an electric field across electrodes. Further, the gas mixture that is employed for forming the plasma will usually be compressed. For example, the gas mixture may be at a pressure of from 2 bar to 10 bar, e.g., from 3 bar to 8 bar or from 4 bar to 7 bar. The flow rate of the gas mixture in the plasma device may, for example, be from 0.1 L/min to 1 L/min, although higher or lower flow rates may be suitable as well. The voltage of the plasma device may be from 10 kV to 20 kV, although higher or lower voltages may also be suitable.

The alkaline aqueous solution employed in step (b) of the method of the invention comprises an alkali and/or alkaline earth metal hydroxide. For example, the alkali and/or alkaline earth metal hydroxide may consist of or comprise NaOH and/or KOH and/or a hydroxide of Mg and/or Ca, although other hydroxides are suitable as well. The concentration of the hydroxide may, for example, range from about 0.1M to about 9M, e.g., from about 0.1M to about 5M, or from about 0.1M to about 3M, and the pH of the solution will often be at least about 8, e.g., at least about 9, at least about 10, or at least about 11.

The concentration of the one or more species of formula NOₓ⁻ in the solution employed in step (b) will often be from 0.1 mM to 50 mM, e.g., at least about 1 mM, although higher or lower concentrations may be suitable as well.

The aqueous electrolyte of the electrochemical cell may be a liquid and/or a gel electrolyte and will often comprise a hydroxide of an alkali metal such as Na and/or K (in particular, KOH) and/or a hydroxide of an alkaline earth metal such as Mg and/or Ca. The concentration of the hydroxide may, for example, range from about 0.1M to about 9M, e.g., from about 0.1M to about 5M, or from about 0.1M to about 3M, and the pH of the electrolyte will often be at least about 8, e.g., at least about 9, at least about 10, or at least about 11.

The installation for carrying out the method of the present invention comprises an electrochemical cell which comprises a cathode, an anode and an aqueous electrolyte. The cathode comprises one or more catalysts which are capable of catalyzing the reduction of NOₓ species to ammonia (and preferably keep the formation of H₂ at a minimum). The anode is made of an electroconductive material which is inert with respect to the electrolyte and resistant to oxidation. For example, the anode may comprise a Ni mesh which is coated with a catalyst that is capable of catalyzing the electrochemical oxidation of water to oxygen.

The electrochemical cell will normally further comprise a separator such as, e.g., an anion exchange membrane or a thin polymeric film which permits the passage of ions and separates the cathode side of the electrolyte from the anode side of the electrolyte.

The method of the invention and in particular, the electrochemical reduction of the NOₓ species to form ammonia may be carried out at a temperature of from about 20° C. to about 200° C. and/or at a pressure from about atmospheric pressure to about 10 atm. For example, it may be (and preferably is) carried out at atmospheric pressure and at ambient (room) temperature (e.g., from about 20° C. to about 30° C.).

The method may be carried out continuously or batchwise, a continuous or semi-continuous operation being preferred.

The catalyst which is capable of catalyzing the electrochemical reduction of NOₓ⁻ species to ammonia may be deposited on a metallic or carbon-based foam, felt, cloth, sponge, mesh etc., and may comprise, for example, one or more of Ni, Co, Ru, Pt, Cu, Fe, La, Y, Ce, Ti, Pd, B. Sr, Ba, W, Rh, Au, Cr, Re, Os, In, Pb, Sb, as such or in the form of physical mixtures, alloys and compounds thereof. The catalyst may also be a ceramic material, such as an oxide, a nitride, a carbide, etc. Further, the catalyst may be present in a variety of shapes such as nanoparticles, cubes, dendrites, rods, flowers, spikes, etc.

Known catalysts which are suitable for the NitRR are disclosed, for example, in Li et al., “The origin of selective nitrate-to-ammonia electroreduction on metal-free nitrogen-doped carbon aerogel catalysts”, Applied Catalysis B: Environmental, vol. 331, 15 Aug. 2023, 122677; Shi et al., “Electrocatalytic nitrate reduction to ammonia via amorphous cobalt boride”, Chemical Communications, issue 62, 2022; Liu et al., “Efficient Electrochemical Nitrate Reduction to Ammonia with Copper-Supported Rhodium Cluster and Single-Atom Catalyst”, Angewandte Chemie, published 17 Mar. 2022; Li et al., “A multifunctional copper single-atom electrocatalyst aerogel for smart sensing and producing ammonia from nitrate”, Jun. 20, 2023, doi.org/10.1073/pnas.2305489120, Zhao et al., “A two-dimensional MXene-supported CuRu catalyst for efficient electrochemical nitrate reduction to ammonia”, Catalysis Science & Technology, 13(19), 5543-5548 (2023), Gao et al., “Alloying of Cu with Ru Enabling the Relay Catalysis for Reduction of Nitrate to Ammonia”, Advanced Materials, 35(19), 2202952 (2023), Chen et al., “Roles of Copper in Nitrate Reduction at Copper-Modified Ru/C Catalysts. The Journal of Physical Chemistry C, 127(6), 2918-2928 (2023), Chen et al., “Efficient conversion of low-concentration nitrate sources into ammonia on a Ru-dispersed Cu nanowire electrocatalyst”, Nature nanotechnology, 17(7), 759-767 (2022). The entire disclosures of these documents are incorporated by reference herein.

Currently preferred catalysts A which are capable of catalyzing the electrochemical reduction of the one or more species of formula NOₓ⁻ to NH₃ at the cathode of the electrochemical cell may comprise one or more of Ni, Co, Ru, Pt, Cu, Fe, La, Y, Ce, Ti, Pd, B. Sr, Ba, W, Rh, Au, Cr, Re, Os, In, Pb, Sb. Other elements may be present as well. For example, a catalyst A may comprise at least Ru and Cu, e.g., in an atomic ratio Ru:Cu from 9:1 to 1:9, such as, e.g., from 8:2 to 2:8, from 7:3 to 3:7, from 6:4 to 4:6 or about 1:1. Further, catalyst A may be present on a mesh such as, e.g., a Ni mesh. Catalyst A may also be present in and/or on a carbon-based or metallic foam, felt, cloth, sponge, mesh, etc. Catalyst A may further be present in the form of particles, for example particles having a size in the range of from 1 nm to 100 μm.

For preparing suitable cathodes, several methods may be used, including electrochemical and/or chemical deposition and/or impregnation and/or other coatings over metallic or carbon-based foam, felt, cloth, sponge, mesh, etc.

The installation for carrying out the method of the present invention comprises an electrochemical cell which comprises a cathode, an anode (preferably a separator) and an aqueous electrolyte. The cathode comprises one or more catalysts A which are capable of catalyzing the reduction of NOₓ⁻ species (and preferably keep the formation of H₂ at a minimum). The anode is made of an electroconductive material which is inert with respect to the electrolyte and to oxidation and comprises one or more catalysts which are capable of catalyzing the oxidation of water to oxygen. For example, the anode may be present in the form of a metal mesh such as, e.g., a Ni mesh, which preferably is coated with a suitable catalyst for the oxidation reaction.

### Experimental Section

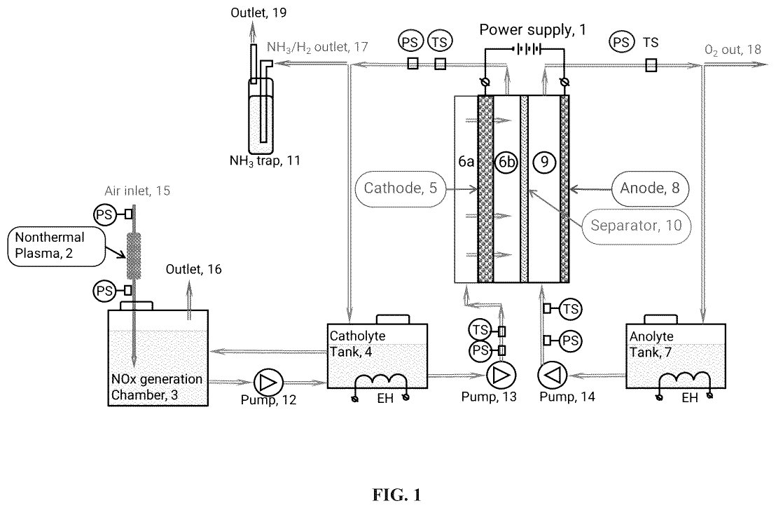

A plasma assisted electrochemical device prototype for electrochemical synthesis of ammonia was constructed. The general design thereof is depicted in FIG. 1, in which the reference signs are as follows:
1 Power Supply (DC 10V; 20A)
2 Air gas plasma (APNTR)
3 NOₓ generation chamber
4 Catholyte tank
5 Cathode
6 a/b Cathode KOH chamber
7 Anolyte tank
8 Anode
9 Anode KOH chamber
10 Separator
11 NH₃ trap
12 KOH+NOₓ⁻ pump
13 Catholyte pump
14 Anolyte pump
15 Air inlet
16 Excess N₂ outlet
17 NH₃/H₂ outlet
18 O₂ outlet
19 H₂ outlet
EH Electrical heater
TS Temperature sensor
PS Pressure sensor

The electrochemical ammonia synthesis using the electrochemical device prototype included the following features/components:
A nonthermal plasma device operated using a compressed air flow (about 6 bar) and a high-voltage plasma generator. The plasma device gas outlet was directly introduced into the electrolyte in the NOₓ⁻ generation reservoir.
A NOₓ⁻ generation reservoir for collecting the reactive nitrogen oxides produced by the plasma device. The reservoir contained KOH in a concentration of from 0.1 M to 3 M.
The NOₓ⁻ reservoir was connected to the catholyte reservoir by a peristaltic pump/centrifugal pump and a feedback loop for introducing NOₓ⁻ to the electrochemical cell.
A cathode comprising NOₓ-reduction catalyst particles (see below) embedded into a metallic (Ni mesh of foam (working electrode).
An anode comprised of a Nickel mesh and a catalyst for the oxidation of water.
A peristaltic pump/centrifugal pump with variable flow rate for streaming the liquid electrolyte in a closed circle from the reservoir tank and into the electrochemical cell.
An alkaline electrolyte of KOH in a concentration of from 0.1 M up to 6.6 M.
Electrolyte reservoir tanks equipped with heating rods enabling temperature control of the electrolyte.
A reference electrode of mercury/mercury oxide—Hg/HgO (MMO), connected to the cell by a salt bridge.
A cathode electrolyte chamber separated from the anode electrolyte chamber by an anion exchange membrane.
An outlet of the cathode electrolyte and gas chambers connected to a trap containing diluted solution of sulfuric acid (H₂SO₄) for retention of synthesized ammonia as an ammonium ion.
An electric device (potentiostat/galvanostat) to apply a constant potential or current between the cathode and anode.

The procedure of operating the cell was as follows:
1. Once the cell is assembled and all electrodes are in place, the cell is loaded with fresh electrolyte.
2. Fresh electrolyte is introduced into the NOₓ⁻ generation reservoir.
3. Fresh sulfuric acid solution is placed in the trap and connected to the cathode gas outlet.
4. N₂ gas is bubbled in the cathode electrolyte and gas chambers in order to purge dissolved oxygen.
5. The electrodes are connected to the potentiostat/galvanostat and the open circuit voltage (OCV) of the system is measured.
6. Compressed air at a pressure of about 6 bar and with a flow rate of 0.1 L/min to 1 L/min is introduced into the plasma device which is operated at a voltage of 10 kV to 20 kV to produce reactive nitrogen oxides which are introduced into the receptacle/reservoir.
7. Generated and dissolved NOₓ⁻ species in the reservoir are passed to the catholyte tank.
8. A constant potential technique between −0.8 to −1.3V vs MMO (mercury/mercury oxide) is applied to the cell for a set time period while electrolyte continues to stream to the chambers and produced ammonia gas is collected in the acid trap. It also is possible to work at constant current with a current density of from 0.001 to 0.1 Acm⁻²
9. The solution in the acid trap is sampled periodically and tested for ammonia presence.
10. Currents and electrode potentials (cathode and anode) are recorded and observed throughout the operation of the cell.

It is preferred to control the temperature of the electrolyte tank (EH) with a feedback loop from the temperature sensors before and after the electrochemical cell, and to control the flow rate by the speed of the liquid pump (centrifugal pump) with a feedback loop from pressure sensors.

The concentration of produced ammonia was determined by colorimetric methods using a UV VIS spectrometer. Two identification and quantification methods were used: one utilizes Nessler's reagent-potassium tetraiodomercurate(II) and another one uses the Berthelot reaction with salicylic acid as an indophenol derivative. NOₓ⁻, i.e., nitrite, concentrations in the reservoir were determined by the colorimetric Greiss method and validated by ion chromatography techniques.

### Initial Results:

An initial examination of the NOₓ⁻ reduction reaction was performed using a 100 ml glass electrochemical H-cell, loaded with 0.1M KOH as electrolyte at both compartments. Addition of nitrate ion at a fixed concentration of 50 mM to the catholyte was used as simulation of the plasma system products. As initial cathode for the nitrate reduction reaction a nickel mesh was used to catalyze the reduction reaction. The mesh was subjected to various activation treatments such as acid etching, sodium borohydride reduction and acetone exposure. Following each treatment, the Ni mesh was placed in the electrochemical cell as cathode and a linear sweep voltammogram was recorded, using the MMO electrode as reference, in the presence of 50 mM potassium nitrate in the electrolyte, and as a control without addition of the nitrate salt.

The acid etching of the Ni mesh was conducted as follows: the Ni mesh was immersed in a 6M or 3M HCl solution in a glass beaker at 25° C., whereafter the beaker was placed in a sonicator and sonicated for 10 minutes (6M) or 30 (3M) minutes. Then the mesh was removed from the acid, thoroughly washed with double-distilled H₂O and then with ethanol, whereafter it was dried in a vacuum oven at 60° C. overnight.

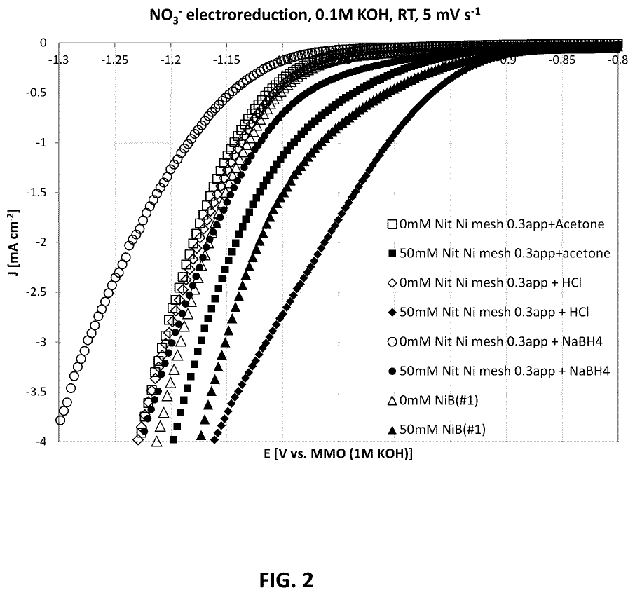

The results of these experiments are presented in FIG. 2 (Ni mesh “0.3 ap” means mesh having openings of 0.3 mm). The highest response was obtained with acid etching of the Ni-mesh where the potential of the nitrate reduction is shifted towards a lower potential, indicating a higher reduction activity of the cathode.

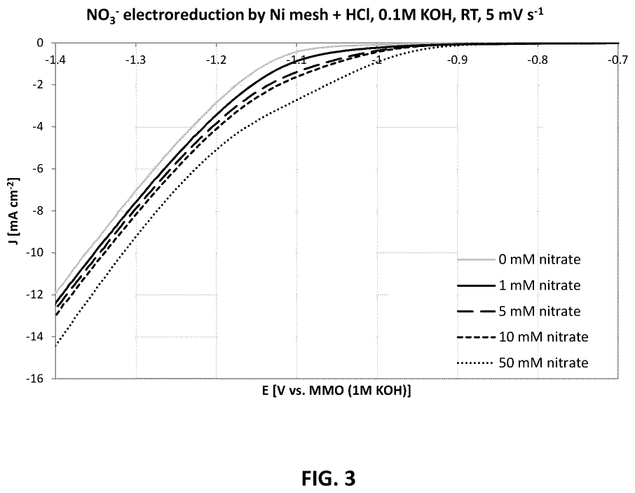

Following this initial result, the experiment of the acid etched Ni mesh was expanded and a linear sweep voltammetry (LSV) experiment at different nitrate concentrations, i.e., 0 mM, 1 mM, 5 mM, 10 mM, and 50 mM was conducted. The results are presented in FIG. 3, which demonstrates that the onset potential, as well as the current density, are increased with an increase in the nitrate concentration. The standard potential of NO₃⁻/NH₃ is higher than the standard potential of H⁺/H₂, as can be seen by the reactions below:

2H⁺+2e⁻↔H₂E₀'₂0.00V vs.RHE(reversible hydrogen electrode)

NO₃⁻+9H⁺+8⁻↔NH₃+3H₂O E₀=0.88V vs.RHE

Therefore, by using a selective catalyst for the NitRR, the electrochemical process can be separated from the hydrogen evolution reaction.

In addition, the limiting current for the nitrate reduction can be observed at the high nitrate concentration of 50 mM (and slightly at 10 mM) at approximately −1.1 V, which indicates that the suggested working potential for chromoamperometry can be near −1.1 V where mass transfer limitation is predominant. The separation between HER to NitRR can also be distinguished, as they start at −1.1 V and ˜−0.9 V, respectively. Table summarizes the onset potentials and limiting currents for the NitRR.

TABLE 1
Onset potential and limiting current for
NitRR derived from the LSV in FIG. 3.

| NO₃⁻ | Onset | Limiting |
|---|---|---|
| concentration | Potential | current |
| [mM] | [V vs. MMO] | [mA cm⁻²] |
| 0 | −1.01 | — |
| 1 | −0.93 | — |
| 5 | −0.92 | — |
| 10 | −0.92 | ~−1.5 @ −1.1 V |
| 50 | −0.89 | ~−2.8 @ −1.1 V |

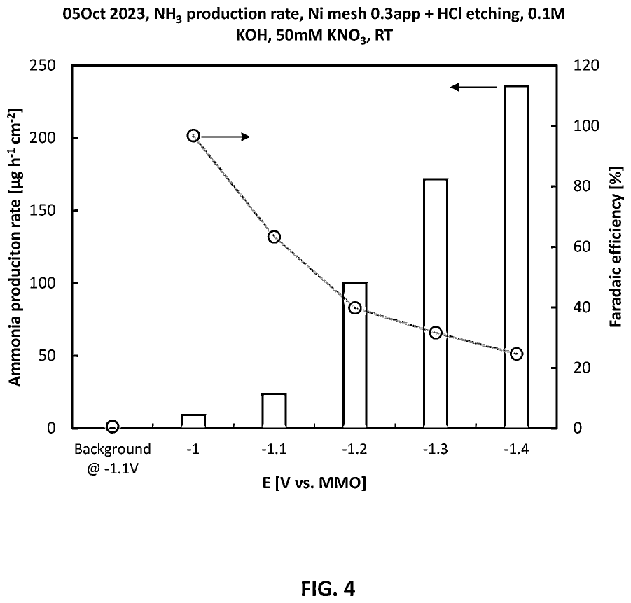

Next, in order to quantify the NOx reduction activity of the acid etched Ni mesh the electrochemical cell was operated at a constant nitrate concentration of 50 mM, varying the applied potential on the cathode and monitoring the amounts of converted nitrates to ammonia in the gas trap and electrolyte compartments and the Faradaic yield of the system. The results are represented in FIG. 4.

The plot is well correlated with the LSV results shown in FIG. 2, where from ˜−1.1V the FE (Faradaic Efficiency) of the NitRR decreases since the HER is initiated (onset of ˜−1.1V). It can be seen that the FE and the ammonia production rate are 2-3 orders of magnitude higher than for the conventional nitrogen reduction reaction (NRR), where the peak FE reaches 96.8% at −1.0V and the peak ammonia production rate reaches −240 μg h⁻¹ cm without a NOₓ selective catalyst. The background of the system is negligible, wherefore the signal relates to NitRR and does not account for any contamination in the electrochemical system.

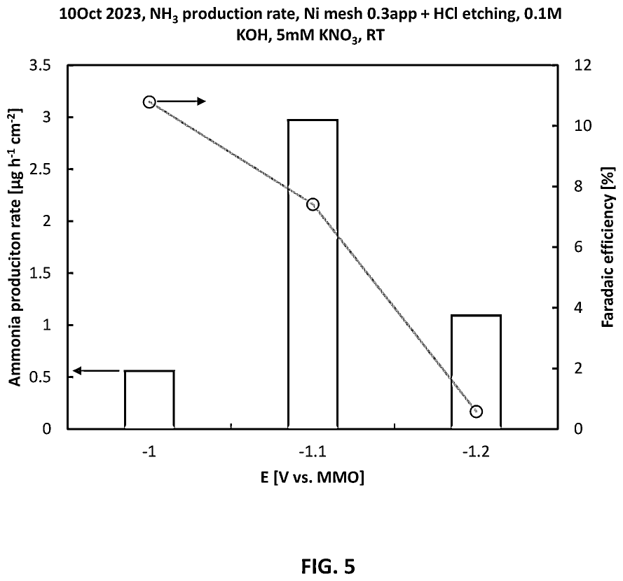

The ammonia production experiment described above was repeated with a lower nitrate concentration of 5 mM, which is an order of magnitude lower. The results are presented in FIG. 5.

A totally different characteristic profile was obtained in this experiment, both for the FE and for the ammonia production rate. The FE decreased from about 65% to about 7% at −1.1 V, which highlights the need for the selection of a catalyst with higher selectivity at the lower range of concentrations (1-10 mM). The production rate is therefore characterized by an optimum value at −1.1V of 3.0 μg h⁻¹ cm², representing a 6-fold decrease when compared to the experiment with 50 mM NO₃⁻. These results emphasize the importance of a selective catalyst for the reduction of NOₓ species.

Further experiments were conducted as follows:

Plasma: A PVA TePla Plasma Pen device was operated according to its manual. Compressed air at 6 bar was streamed to the device. A 1000 ml glass beaker was filled with 500 ml 1M KOH. The pen was placed in a glass tube cone where the tip of the cone was submerged about 1 cm in the KOH solution. The plasma torch was placed 5-6 cm above the liquid surface. The KOH solution was stirred using a magnetic stirrer. Subsequently the plasma was ignited for 30 min and samples of the KOH solution were collected every 10 min. The NOₓ⁻ concentration was determined by the Greiss test.

In the above experiment the presence of nitrate NO₃ ions in the electrolyte could not be detected, indicating that the preferred activation of nitrogen in this plasma results in the formation of nitrite. The following nitrite concentrations [ppm] were found after 10 min, 20 min and 30 min: 35.85, 59.96, 72.32.

Electrochemical cell: An electrochemical cell was first washed with distilled water and then assembled. Each chamber consisted of an electrode holder, a gas purging tube with sintered glass, and a gas outlet stream. The catholyte had a salt bridge for the reference electrode. The catholyte and the anolyte were separated by an Ionomer AF3 membrane.

All experiments were conducted at room temperature with a 1M KOH solution and an Ar gas flow rate of 0.1 L/min. The outlet streams of the catholyte and the anolyte were connected to acid traps (5 mM H₂SO₄). The working electrode was a Ni mesh with a 0.3 mm aperture which had been etched with HCl (as described above) onto which a CuRu catalyst (see below) had been deposited. The reference electrode was MMO (1M KOH) and the anode consisted of a Nickel sheet.

A chronoamperometry (CA) was conducted for 1 h at identical conditions using either a plasma-treated solution or a 5 mM KNO₃ solution or a 50 mM of KNO₃ solution at applied potentials that were chosen according to the LSV results. Samples were taken at t=0 and t=1 h from each part of the system. At the end of the experiment, samples from the acid traps were analyzed by Nessler's reagent and samples from the electrolyte were analyzed by the salicylate method.

The FE of the CuRu catalyst (see below, Cu:Ru=1:1) was found to be 100% +/−2% and 89. 07% at −0.85 V and −0.9 V (vs.MMO), respectively.

The ammonia production rate of the catalyst was found to be 603.9 μg h⁻¹ cm² and 1240.9 μg h⁻¹ cm at −0.85 V and −0.9 V (MMO), respectively.

It was decided to focus on a concentration of 5 mM NO₃ since it was believed that the plasma will produce this concentration of NOₓ⁻ per hour.

From the LSV the E onset and the ΔE window for the NitRR can be determined. ΔE is the difference between E onset for the NitRR and E onset for the HER.

The following results were obtained:

| | E onset | ΔE |
|---|---|---|
| Catalyst | [V vs. MMO] | window [mV] |
| Cu | −0.83 | 215.8 |
| Ru | −0.67 | 236.1 |
| Cu25Ru75 | −0.67 | 267.6 |
| Cu50Ru50 | −0.68 | 304.5 |
| Cu75Ru25 | −0.74 | 366.8 |

The E onset indicates which catalyst has the best intrinsic properties for the NitRR reaction (Ru) and the ΔE window indicates which catalyst is the most selective catalyst (Cu₇₅Ru₂₅).

At E=−0.9 vs. the reference electrode the FE of the NitRR was about 96%.

NitRR experiment with solution containing plasma derived NO₂:

The KOH solution activated by the torch plasma described above was used as nitrite containing substrate in an NitRR experiment performed in a glass H cell. The cathode used for this experiment was a 2.5 cm² nickel mesh coated with a Cu-Ru catalyst (Cu:Ru=1:1), the potential applied was −0.9V for one hour.

In a first experiment the electrolyte contained about 40 ppm nitrite, corresponding to roughly 1 mM nitrite. Ammonia was detected in the electrolyte with a production rate of 1485.3 μg/h corresponding to 675 μg/h/cm², the FE was 75%.

The second batch of electrolyte contained 72 ppm nitrite, corresponding to about 3 mM nitrite, was tested in the same system under the same conditions. Ammonia was detected in the electrolyte at a production rate of 1152.5 μg/h corresponding to 524 μg/h/cm² and the FE was 99%, indicating an almost full conversion of the current with the experimental error of about ±5% due to deviations arising from the colorimetric method used.

### Preparation of RuCu catalyst

### Materials:

Nickel mesh (electrode size 5 cm²)
Ethanol
3M HCl
Solution A: 2.8180 g RuCl₃ and 2.1311 g CuCl₂ in 50 ml distilled water.
Solution B: 1.8915 g NaBH₄ and 0.2000 g NaOH in 50 ml distilled water.

### Solution a Steps:

The salts were placed in a beaker.
The distilled water was added to the beaker.
The mixture was stirred with a glass rod for a few seconds until the solution became homogeneous.

### Solution B Steps:

The NaOH was measured in an Erlenmeyer flask.
The distilled water added, and the mixture was swirled until the NaOH had fully dissolved.
The NaBH₄ was added, and the mixture was swirled until the NaBH₄had fully dissolved.

Reaction Steps:
1. Ni mesh samples were submerged in 3M HCl for 20 min.
2. The samples were washed three times with distilled water and ethanol.
3. Every sample was submerged in solution A for about 3 seconds and then submerged in solution B for 10 seconds.
4. The samples were washed with distilled water to remove loose particles and NaBH₄.
5. Steps 3 and 4 were repeated 3 times. 6. The samples were dried in a vacuum overnight.

The resulting CuRu/Ni mesh had a nano sponge morphology (coral-like) of Cu and Ru present on the Ni mesh. Cu is reduced easily (compared to the Ru), wherefore most of the Ru was deposited on the Cu. The CuRu did not cover the entire Ni mesh surface. The stoichiometry (atomic %) according to an electron diffraction spectrum measurement is on average CusRu/Ni mesh.

The FE of the produced CuRu catalyst using 5 mM nitrate added to the aqueous alkaline solution was found to be 45.29% and 96.46% at −0.85 V and −0.9 V, respectively. The ammonia production rate under these conditions was found to be 23.02 μg/h/cm² and 90.72 μg/h/cm² at −0.85 V and −0.9 V, respectively.

To sum up, the present invent invention provides the following:
1. A method for the electrochemical synthesis of ammonia (NH₃), wherein the method comprises:
   (a) forming from a gas mixture comprising nitrogen and oxygen as starting material an APNTP in a plasma device,
   (b) introducing the APNTP formed in the plasma device into an aqueous electrolyte solution, alkaline or neutral, to form a solution of one or more species of formula NOₓ⁻ in which x is 1, 2 or 3,
   (c) contacting the solution of (b) with a cathode of an electrochemical cell which comprises the cathode, an anode and an aqueous electrolyte, the cathode comprising a catalyst A which is capable of catalyzing the electrochemical reduction of the one or more species of formula NOₓ⁻ to NH₃ at the cathode, and
   (d) applying a potential or current over the electrochemical cell to effect the electrochemical synthesis of ammonia.
2. The method of item 1, wherein in (a) the APNTP is formed by direct application of an electric field across electrodes.
3. The method of item 1 or item 2, wherein in (a) a compressed gas mixture is employed.
4. The method of item 3, wherein a flow rate of the gas mixture in the plasma device is from 0.1 L/min to 1 L/min.
5. The method of any one of the preceding items, wherein a voltage of the plasma device is from 10 kV to 20 kV.
6. The method of any one of the preceding items, wherein the aqueous electrolyte solution of (b) comprises an alkali and/or alkaline earth metal hydroxide.
7. The method of item 6, wherein the alkali and/or alkaline earth metal hydroxide comprises KOH.
8. The method of any one of items 6 and 7, wherein a concentration of the alkali and/or alkaline earth metal hydroxide in the solution of (b) is from 0.1M to 3M.
9. The method of any one of the preceding items, wherein the electrochemical cell further comprises a separator.
10. The method of item 9, wherein the separator comprises an anion exchange membrane.
11. The method of any one of the preceding items, wherein the aqueous electrolyte in the electrochemical cell is an aqueous solution of an alkali and/or alkaline earth metal hydroxide.
12. The method of item 11, wherein the alkali and/or alkaline earth metal hydroxide comprises KOH.
13. The method of any one of items 11 and 12, wherein a concentration of the alkali and/or alkaline earth metal hydroxide in the aqueous electrolyte is from 0.1M to 3M.
14. The method of any one of the preceding items, wherein the one or more species of formula NOₓ⁻ comprise at least a nitrite (NO₂) species.
15. The method of any one of the preceding items, wherein a concentration of the one or more species of formula NOₓ⁻ in the solution of (b) is from 1 mM to 50 mM.
16. The method of any one of the preceding items, wherein the catalyst A comprises one or more of Ni, Co, Ru, Pt, Cu, Fe, La, Y, Ce, Ti, Pd, B. Sr, Ba, W, Rh, Au, Cr, Re, Os, In, Pb, Sb.
17. The method of any one of the preceding items, wherein the catalyst A comprises at least Ru and Cu.
18. The method of item 17, wherein the atomic ratio Ru:Cu in the catalyst is from 90:10 to 10:90.
19. The method of any one of items 18 and 19, wherein the catalyst A is present on a Ni mesh.
20. The method of any one of the preceding items, wherein the catalyst A is present on and/or in a carbon-based or metallic foam, felt, cloth, sponge, mesh.
21. The method of any one of the preceding items, wherein the catalyst A is present in the form of particles having a size of from 1 nm to 100 μm or in the form of a nano sponge.
22. An installation for carrying out the method of any one of items 1 to 21, wherein the installation comprises (i) a plasma device capable of forming from a gas mixture comprising nitrogen and oxygen an APNTP and (ii) an electrochemical cell which comprises a cathode, an anode and an aqueous electrolyte, the cathode comprising catalyst A which is capable of catalyzing the electrochemical reduction of one or more species of formula NOₓ⁻ to NH₃.
23. The installation of item 22, wherein the plasma device is configured to form the APNTP by direct application of an electric field across electrodes.
24. The installation of any one of items 22 and 23, wherein a voltage of the plasma device is from 10 kV to 20 kV.
25. The installation of any one of items 22 to 24, wherein the aqueous electrolyte comprises an alkali and/or alkaline earth metal hydroxide.
26. The installation of item 25, wherein the alkali and/or alkaline earth metal hydroxide comprises KOH.
27. The installation of any one of items 25 and 26, wherein the concentration of the alkali and/or alkaline earth metal hydroxide in the electrolyte is from 0.1M to 6.6M.
28. The installation of any one of the preceding items, wherein the electrochemical cell further comprises a separator.
29. The installation of item 28, wherein the separator comprises an anion exchange membrane.
30. The installation of any one of items 22 to 29, wherein the catalyst A comprises one or more of Ni, Co, Ru, Pt, Cu, Fe, La, Y, Ce, Ti, Pd, B. Sr, Ba, W, Rh, Au, Cr, Re, Os, In, Pb, Sb.
31. The installation of any one of items 22 to 30, wherein the catalyst A comprises at least Ru and Cu.
32. The installation of item 31, wherein an atomic ratio Ru:Cu is from 90:10 to 10:90.
33. The installation of any one of items 31 and 32, wherein the catalyst A is present on a Ni mesh.
34. The installation of any one of items 22 to 33, wherein the apparatus further comprises a receptacle which contains an alkaline aqueous solution for receiving the APNTP from the plasma device.
35. The installation of item 34, wherein the alkaline aqueous solution comprises an alkali and/or alkaline earth metal hydroxide.
36. The installation item 34, wherein the alkali and/or alkaline earth metal hydroxide comprises KOH.
37. The installation of any one of items 35 and 36, wherein the concentration of the alkali and/or alkaline earth metal hydroxide in the aqueous solution is from 0.1M to 3M.
38. The installation of any one of items 22 to 37, wherein the installation further comprises a potentiostat and/or a galvanostat.
39. A method of converting a gas mixture comprising nitrogen and oxygen into one or more species of formula NOₓ⁻ in which x is 1, 2 or 3, wherein the method comprises forming from the gas mixture as starting material an APNTP and introducing the formed APNTP into an aqueous electrolyte solution to form a solution of the one or more species of formula NOₓ⁻ in the aqueous electrolyte solution.
40. The method of item 39, wherein the one or more species of formula NOₓ⁻ comprise at least a nitrite (NO₂) species.
41. A catalyst for catalyzing the electrochemical synthesis of ammonia, wherein the catalyst is capable of catalyzing the reduction of species of formula NOₓ⁻ in which x is 1, 2 or 3 to ammonia at the cathode of an electrochemical cell and comprises at least Cu and Ru in an atomic ratio of from 9:1 to 1:9.
42. The catalyst of item 41, wherein the catalyst is present on a Ni mesh and/or is present as a nano sponge.
43. The catalyst of any one of items 41 and 42, wherein the catalyst is obtainable by contacting an aqueous solution of a Cu salt and a Ru salt with a reducing agent.
44. The catalyst of item 43, wherein the Cu salt and the Ru salt are reduced by NaBH₄.

What is claimed is:

1. A method for the electrochemical synthesis of ammonia (NH₃), wherein the method comprises:
(a) forming from a gas mixture which comprises nitrogen and oxygen an atmospheric pressure nonthermal plasma (APNTP) in a plasma device,
(b) introducing the APNTP formed in the plasma device into an aqueous electrolyte solution, alkaline or neutral, to form a solution of one or more species of formula NOₓ⁻ in which x is 1, 2 or 3,
(c) contacting the solution of (b) with a cathode of an electrochemical cell which comprises the cathode, an anode and an aqueous electrolyte, the cathode comprising a catalyst A which is capable of catalyzing the electrochemical reduction of the one or more species of formula NOₓ⁻ to NH₃ at the cathode, and
(d) applying a potential or current over the electrochemical cell to effect the electrochemical synthesis of ammonia.

2. The method of claim 1, wherein in (a) the APNTP is formed by direct application of an electric field across electrodes.

3. The method of claim 1, wherein in (a) a compressed gas mixture is employed and/or a flow rate of the gas mixture in the plasma device is from 0.1 L/min to 1 L/min.

4. The method of claim 1, wherein a voltage of the plasma device is from 10 kV to 20 kV.

5. The method of claim 1, wherein the aqueous electrolyte solution of (b) comprises an alkali and/or alkaline earth metal hydroxide.

6. The method of claim 1, wherein the aqueous electrolyte in the electrochemical cell is an aqueous solution of an alkali and/or alkaline earth metal hydroxide.

7. The method of claim 1, wherein the one or more species of formula NOₓ⁻ comprise at least a nitrite (NO₂) species.

8. The method of claim 1, wherein the catalyst A comprises one or more of Ni, Co, Ru, Pt, Cu, Fe, La, Y, Ce, Ti, Pd, B, Sr, Ba, W, Rh, Au, Cr, Re, Os, In, Pb, Sb.

9. An installation for carrying out the method of claim 1, wherein the installation comprises (i) a plasma device capable of forming from a gas mixture that comprises nitrogen and oxygen an APNTP and (ii) an electrochemical cell which comprises a cathode, an anode and an aqueous electrolyte, the cathode comprising a catalyst A which is capable of catalyzing the electrochemical reduction of one or more species of formula NOₓ⁻ to NH₃.

10. The installation of claim 9, wherein the plasma device is configured to form the APNTP by direct application of an electric field across electrodes.

11. The installation of claim 10, wherein a voltage of the plasma device is from 10 kV to 20 kV.

12. The installation of claim 9, wherein the aqueous electrolyte comprises an alkali and/or alkaline earth metal hydroxide.

13. The installation of claim 9, wherein the catalyst A comprises one or more of Ni, Co, Ru, Pt, Cu, Fe, La, Y, Ce, Ti, Pd, B, Sr, Ba, W, Rh, Au, Cr, Re, Os, In, Pb, Sb.

14. The installation of claim 9, wherein the apparatus further comprises a receptacle which contains an alkaline aqueous solution for receiving the APNTP from the plasma device.

15. The installation of claim 14, wherein the alkaline aqueous solution comprises an alkali and/or alkaline earth metal hydroxide.

16. The installation of claim 9, wherein the installation further comprises a potentiostat and/or a galvanostat.

17. A method of converting a gas mixture which comprises nitrogen and oxygen into one or more species of formula NOₓ⁻ in which x is 1, 2 or 3, wherein the method comprises forming from the gas mixture an APNTP and introducing the formed APNTP into an aqueous electrolyte solution to form a solution of the one or more species of formula NOₓ⁻ in the alkaline aqueous solution.

18. A catalyst for catalyzing the electrochemical synthesis of ammonia, wherein the catalyst is capable of catalyzing the reduction of species of formula NOₓ⁻ in which x is 1, 2 or 3 to ammonia at a cathode of an electrochemical cell and comprises at least Cu and Ru in an atomic ratio of from 9:1 to 1:9.

19. The catalyst of claim 18, wherein the catalyst is present on a Ni mesh.

20. The catalyst of claim 18, wherein the catalyst is obtainable by contacting an aqueous solution of a Cu salt and a Ru salt with a reducing agent.
